(19) United States
(12) Patent Application Publication
(10) Pub. No.: US 2008/0000154 A1
(43) Pub. Date: Jan. 3, 2008

(54) Vase for cultivating orchids

(76) Inventor: Gottfried Schubiger, Rapperswil (CH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/711,481

(22) Filed: Feb. 27, 2007

(30) Foreign Application Priority Data
Feb. 28, 2006 (CH) CH-00312/06

(51) Int. Cl. A01G 9/02

(52) U.S. Cl. 47/66.7; 47/65.5

(57) ABSTRACT

A vase is described, which consists of a glass body, which proceeding from a vase foot (10), is formed by a vase outer wall (12), and from the vase outer wall (12) merges into a bulge apex (15) and subsequently into a bulge edge (15), and forms a vase bulge (13) by way of this, which opens into a vase opening (11). The glass body is filled with a nutrient solution (4) into which a culture medium (3) is immersed, to which the roots (20) of an orchid (2) adhere. A climate which imitates the natural habitat of the orchids arises due to the special shape of the vase bulge (13) and the almost complete closure of the vase opening (11) by the roots (20) and the leaves (22). The use of charcoal (3) as a culture medium (3) leads to the orchid only having to be supplied with nutrient solution (4) seldomly, and may prevent a rotting of the roots (20).

### TECHNICAL FIELD

The present invention relates to a vase for cultivating orchids, comprising a glass body with a middle axis, which includes a vase foot and a vase outer wall which runs into a vase opening, which is suitable for receiving a nutrient solution and a porous culture medium, to which an orchid adheres.

### STATE OF THE ART

In recent years, the cultivation of orchids has become increasingly popular, and the range and availability of cultivation hybrids has become larger, and thus more and more amateurs have attempted to cultivate orchids in domestic rooms, vitrines and greenhouses. Above all, it is thanks to the mass production of orchids in Taiwan, Thailand and the Netherlands, that on average one comes across several orchids per household.

As a rule, orchids blossom all year round, thus in an unlimited manner, depending on the growth type. This is only possible with optimal conditions with regard to air humidity, light exposure and nutrient supply.

With orchid enthusiasts, there exists a great necessity to imitate the natural habitat, so that an optimal care of the orchids, and thus a longer life duration is ensured.

Orchids grow in different ways and manners. The growth of orchids on other plants is called epiphytic, wherein the orchids are not parasites. Some orchid species also grow terrestrially, thus on the ground, or lithophytically, on rocks or stones. What they have in common, is that they form air roots, via which water and nutrients are absorbed, and which are not buried in earth or humus.

It is the epiphytic orchids which are most commonly sold in the shops. These are mostly obtainable in simple plastic pots with a culture medium, the medium to which the orchids adhere with their roots. These are mostly placed on wood chippings, small twigs or pieces of bark, for simulating the natural habitat of the orchids, by which means natural tree branches are imitated. Recently, culture mediums of porous clay, foamed polystyrene or coconut fibres have been obtainable.

In order to imitate the natural habitat of the orchids as accurately as possible, one must ensure a humid-warm climate in the vicinity of the plant. Whilst the higher temperatures present no great problem, the orchids, depending on the absorption capacity of the applied culture medium, must be frequently provided with water and also with nutrients from time to time.

It has been found that the relative air humidity must be between 40% and 80% for the orchids to feel comfortable. This is not easy to accomplish above all in the partly completely excessively heated living rooms in Europe, since these dry out, and the relative air humidity may often drop to 20% with living rooms with double glazing.

The generous watering of the orchid is not a solution for achieving the desired humidity level. Due to the low relative humidity in the room air, the orchids evaporate much water through their leaves, by which means one needs to continuously re-water, without thereby the air roots having to lie in water.

In the previously used retention containers and vases, the orchid with its roots firmly adheres to the applied culture, in a manner such that the roots to the larger part lie exposed, and the surface of the root may absorb humidity from the surroundings in an unhindered manner. By way of this, the plants not only lose moisture on account of the surfaces of the leaves, but also through their roots.

Added to this is the fact that the previously used culture media, such as wood- and bark pieces, as well as clay and artificially manufactured materials, tend to decay, rot and become contaminated with fungi when they are located in a humid environment.

### DESCRIPTION OF THE INVENTION

It is the object of the present invention to provide a vase in which orchids, adapted to their natural habitat, may flourish, wherein a minimal effort with regard to watering and other care is necessary.

This object is achieved by a device with the features of patent claim 1.

Advantageous embodiments are to be found in the dependent claims.

### BRIEF DESCRIPTION OF THE DRAWINGS

The invention is hereinafter described in combination with the drawings.

FIG. 1 shows a view of the vase according to the invention, with an orchid.

FIG. 2 shows a section through the vase according to the invention, together with the culture medium and the nutrient solution and with an orchid placed in the vase.

FIG. 3 shows a section through the glass body, in detail.

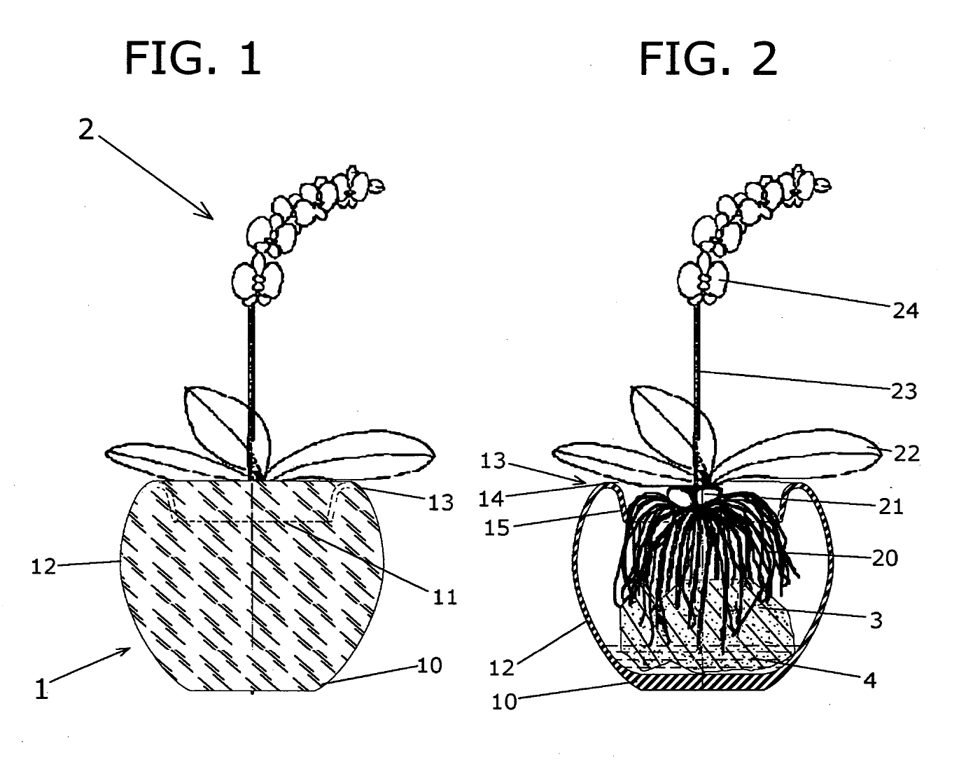

### DESCRIPTION

The present invention is a vase for cultivating orchids, in particular epiphytically growing orchids 2, which consists of a glass body 1 which is formed by a vase foot 10 proceeding from a vase outer wall 12.

The vase outer wall 12, lying opposite the vase foot 10, forms a vase bulge 13. This vase bulge 13 is formed by a bulge apex 14 running in a horizontal or parabolic manner, and running into a bulge edge 15. A vase opening 11 is arranged at that end of the bulge edge 15 which faces the vase foot 10

The vase body 1 shaped in this manner forms a light-permeable and water-tight container, into which an orchid 2, consisting in each case of one or more roots 20, pseudo-bulbs 21, leaves 23, panicles 23 and blossoms 24 is situated. The roots 20 are brought into contact with a fluid-absorbing and porous culture medium 3, on which the orchid 2 finds support. The orchid 2 with the culture medium 3 and the attached roots 20 at the front, is introduced through the vase opening 11 into the glass body 1 and is placed resting on the vase foot 10.

The diameter of the vase opening 11 must be selected such that the roots 20 adhering to the culture medium 3 and the pseudo-bulbs 21, may be led through the vase opening 11, so that only the leaves 22, the panicle 23 and the blossoms 24 may project beyond the bulge apex 14 out of the glass body 1. The roots 20, and pseudo-bulbs 21 which may be present depending on the orchid species, and which serve for the storage of water and nutrients, are then located within the glass body 1. The mostly stem-like roots 20 and the pseudo-bulbs 21 close off of the inner space of the glass body 1, so that only little air and moisture may be exchanged through the vase opening 11. The leaves 22 of the orchid 2 lie additionally over the vase bulge, by which means the glass body 1 is additionally closed off. The shape of the vase bulge 13 and the parts of the orchid 2 lying within the glass body 1, the roots 20 and the pseudo-bulbs 21, thus create an almost closed volume in which one may produce the climate favourable for the orchids 2.

If one observes the middle axis 16 of the glass body, then trials have shown that the bulge edge 15 and the middle axis 16 should enclose an angle a which should be larger than zero and smaller than 90°. Then the curvature of the vase bulge 13 is designed such that the inside of the glass body 1 is sealed off in an optimal manner by the roots 20 and the pseudo-bulbs 21, and thus a special climate may form within the glass body 1.

Orchids 2 in their natural habitat are often to be found on trees, in order absorb as much light as possible, also via their roots 20. Apart from the absorption of water and nutrients, the roots 20 also have the task of carrying out a photosynthesis. In order to support this process, and thereby to avoid the roots 20 from growing out of the vase, the vase is designed as a glass body 1.

The glass body 1 is then filled with a nutrient solution 4, so that the culture medium 3 is moistened, which absorbs fluid on account of its absorption properties. The roots 20 of the orchid in turn absorb nutrient solution 4. On filling, one should take care that the fluid level does not rise to such an extent, that the roots 20 project into the fluid. The nutrient solution may be water. This water may be untreated or softened tap water. Since orchids 2 in their natural habitat only receive little nutrients, it is advisable for the orchid enthusiast to fertilise in an extremely sparse manner. From time to time, one may add orchid fertiliser available in the specialist shops, to the nutrient solution

Series of trials have shown that charcoal 3 is an ideal culture medium 3. This mixture of organic compounds with a very high carbon component forms porous pieces with a low density. The pieces of the charcoal 3 may be portioned without any tool, and may be adapted individually to each orchid 2. Due to the microscopically small channels, charcoal has a high absorption capability, since the pores are able to accommodate a large quantity of fluid. An adequate supply of fluid without great effort with regard to watering may be achieved by way of this. Charcoal to this date has been used for clarifying and decolouring fluids, for disinfecting and for preserving substances prone to rotting. It has been shown in the trial series, that charcoal 3 prevents a rotting and decay of roots 20, and even encourages a healing of injuries to the roots 20.

The climate which imitates the natural habitat of an orchid 2 arises in the glass body in the following manner.

The vase foot 10 of the glass body 1 absorbs heat via the air surrounding it, so that the vase foot 10 is heated, by which means the temperature of the nutrient solution 4 also rises. The charcoal 3 absorbs heat, since the light radiation may be incident from the outside through the glass body 1 onto the charcoal in an unhindered manner. These effects lead to a temperature gradient arising along the middle axis 16. Water 4 evaporates out of the volume of the nutrient solution 4 and out of the pores of the charcoal 3 on account of the heat in the region of the vase foot 10, and an air/water vapour mixture rises upwards in the direction of the vase opening 11. Only little air may escape out of the vase opening 11 on account of the described shape of the vase bulge 13, in combination with the arrangement of the roots 20, the pseudo-bulbs 21 and the leaves 22 of the orchid 2.

Lower temperatures prevail in the vicinity of the vase opening 11 on account of the temperature gradients, not least because of the occurring evaporation chill on the surface of the roots 20. Water vapour condenses in the vicinity of the vase opening 11 on the glass body 1 and on the roots 20 and the pseudo-bulbs 21 due to the lower temperatures, by which means the orchid 2 is kept moist but is not saturated.

An air/water vapour flow is formed in the volume within the glass body 1, which is not reached by the roots 20. Warm and humid air rises upwards where it may not escape, and the water vapour is therefore condensed, and the air thereby is cooled again and sinks in the direction of the vase foot 10.

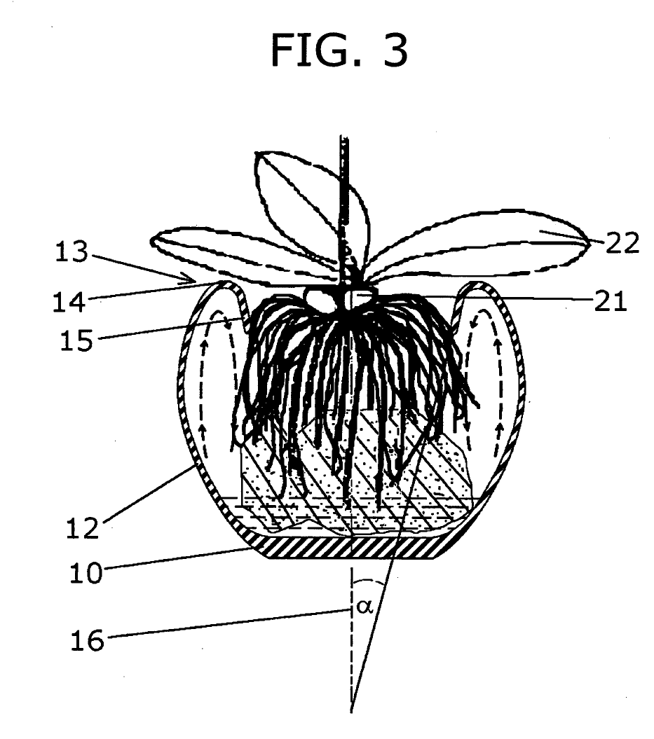

The humidity which is dissipated by the roots 10 may not escape out of the glass body 1, and is led again to the roots 20. This circulation is indicated in FIG. 3 by the arrows, and leads to the fact that the nutrient solution 4 evaporates less rapidly and therefore needs only to be refilled at longer intervals, specifically only when the evaporation of the moisture from the leaves 22, the panicle 23 and the blossoms 24 has taken place.

Since the use of charcoal 3 as a culture medium prevents the rotting of the roots 20 and acts in a disinfecting manner, it is possible to delay the re-potting of the orchid 2, and even to avoid this.

### LIST OF REFERENCE NUMERALS

1 glass body
10 vase foot
11 vase opening
12 vase outer wall
13 vase bulge
14 bulge apex
15 bulge edge
16 middle axis
2 orchid
20 root
21 pseudo-bulb
22 leaf
23 panicle
24 blossom
3 culture medium=charcoal
4 nutrient solution=water

1. A vase for cultivating orchids, comprising a glass body with a middle axis, which includes a vase foot and a vase outer wall which opens into a vase opening, said glass body being suitable for receiving a nutrient solution and a porous culture medium to which an orchid adheres, characterised in that the vase outer wall comprises a vase bulge above the opening into the vase opening, which includes a bulge apex and a bulge wall which runs at a given angle to the middle axis of the glass body.

2. A vase according to claim 1, characterised in that the angle α between the bulge edge and a middle axis of the glass body is larger than zero and smaller than 90°.

3. A vase according to claim 1, characterised in that the bulge apex runs in a horizontal manner.

4. A vase according to claim 1, characterised in that the bulge apex runs in a parabolic manner.

5. A vase according to claim 1, characterised in that the glass body is provided with a culture medium.

6. A vase according to claim 5, characterised in that the culture medium is charcoal.

7. The use of the vase according to claim 1, characterised in that the vase opening is passable for pseudo-bulbs and roots of an orchids.

8. The use of the vase according to claim 7, characterised in that the roots and the leaves of the orchid lie above the bulge apex and thus largely prevent an exchange of the air in the glass body with the surroundings.
